(19) United States
(12) Patent Application Publication
(10) Pub. No.: US 2022/0277060 A1
(43) Pub. Date: Sep. 1, 2022

(54) SYSTEM AND METHOD FOR CAPTURING COMPLEX RIGHTS RELATING TO DATA LICENSES

(71) Applicant: JPMorgan Chase Bank, N. A., New York, NY (US)

(72) Inventors: Ilya Slavin, Brooklyn, NY (US); Jairy T. Meneses Gómez, Buenos Aires (AR); Michelle Roberts, St. Albans (GB); Jorge A. Di Pasqua, Buenos Aires (AR); Gerardo Luis Kilmurray, Buenos Aires (AR)

(21) Appl. No.: 17/187,036

(22) Filed: Feb. 26, 2021

(51) Int. Cl. G06F 21/10; G06F 16/904

(52) U.S. Cl. CPC G06F 21/105; G06F 16/904

(57) ABSTRACT

An embodiment of the present invention is directed to a tool that captures the meaning of the agreement in an effective and efficient manner. An embodiment of the present invention is directed to a complex data rights capturing tool. The complex data rights capturing tool may enable users to select usage rights, define the asset (e.g., dataset) and define the scope of use for the defined dataset.

### FIELD OF THE INVENTION

The invention relates generally to a system and method for implementing a complex data rights capturing tool.

### BACKGROUND OF THE INVENTION

Global entities, such as financial institutions, may spend over hundreds of millions of dollars on market data, which can be used by hundreds of applications and thousands of individual users. This results in agreements with hundreds of data vendors and Exchanges, some of which could be very complicated. For a large financial entity, it is common to have thousands of unique and individual agreements in force. Nearly all agreements are on vendor originated paper, diluting definitions of terms. New or replacement agreements are signed regularly with cost increases up to 25% (annually) in some cases. Currently, agreements are managed manually in paper format. Most lines of businesses (LOBs) do not fully understand usage rights and entitlements. This results in increased risk and non-compliance issues. In addition, it is common to have concurrent exchange audits at any given time.

For a financial institution, there is a tremendous amount of contracts for market data where each contract can be unique in nature and style. Current solutions rely on natural language processing to capture complex data rights. However, this approach falls short because there is generally little to no similarity between agreements. Other solutions simply offer a collection of text boxes which require manual data entry of agreement terms. The ability to manage many contracts is not unique to market data or financial companies and is an issue relevant to many lines of business and industries. For example, consumer banking entities may manage a large amount of agreements for credit reporting and other purposes.

Accordingly, current solutions fail to accurately and effectively capture complex data rights in a streamlined and meaningful manner. This results in lack of coordination between business support groups or lines of business, and there is a risk of overspend and wasted resources. Moreover, an even larger risk stems from unintentional non-compliance, which can be detected by never-ending exchange audits, resulting in fines, reputational risk and threat to existing business models.

These and other drawbacks exist.

### SUMMARY OF THE INVENTION

According to an embodiment, the invention relates to a system that provides a complex data rights capturing tool. The system comprises: a portal that interfaces with user within a line of business via a network communication; a memory component that stores data relating to a plurality of contracts associated with the line of business; and an analytics engine that comprises a computer processor and is coupled to the memory component and the portal; the computer processor is further configured to perform the steps of: initiating, via the portal, the data rights capture tool; providing, via the portal, a set of data fields associated with an asset, the set of data fields comprising: service name, data frequency, source vendor data and carrier vendor data; receiving, via the portal, one or more data inputs associated with the set of data fields; providing, via the portal, a scope of use for the asset, wherein the scope of use relates to one or more of: physical restriction, logical restriction and line of business restriction; receiving, via the portal, one or more data inputs associated with the scope of use for the asset; providing, via the portal, one or more usage rights for the asset; and providing, via the portal, a visualization of the asset, the scope of use for the asset and the one or more usage rights for the asset.

According to another embodiment, the invention relates to a system that provides a complex data rights capturing tool. The system comprises: a portal that interfaces with user within a line of business via a network communication; a memory component that stores data relating to a plurality of contracts associated with the line of business; and an analytics engine that comprises a computer processor and is coupled to the memory component and the portal; the computer processor is further configured to perform the steps of: initiating, via the portal, the data rights capture tool; defining a contract hierarchy and creating a consolidated version of one or more terms associated with the contract hierarchy; identifying a service and a dataset covered by the contract hierarchy and defined by the one or more terms; identifying, via the portal, a scope of use for the service, wherein the scope of use relates to what one or more services are being defined and who will use an associated dataset; receiving, via the portal, one or more conditions relating to distribution of the service; receiving, via the portal, one or more duties that apply to one or more permissions relating to distribution of the service; and generating, via the portal, a visualization of a set of constraints and duties associated with the permission granted to redistribute data.

According to another embodiment, the invention relates to a method that implements a complex data rights capturing tool. The method comprises the steps of: initiating, via a portal, the data rights capture tool, wherein the portal interfaces with a user within a line of business via a network communication; defining, via an analytics engine comprising a computer processor, a contract hierarchy and creating a consolidated version of one or more terms associated with the contract hierarchy; identifying, via the analytics engine, a service and a dataset covered by the contract hierarchy and defined by the one or more terms; identifying, via the portal, a scope of use for the service, wherein the scope of use relates to what one or more services are being defined and who will use an associated dataset; receiving, via the portal, one or more conditions relating to distribution of the service; receiving, via the portal, one or more duties that apply to one or more permissions relating to distribution of the service; and generating, via the portal, a visualization of a set of constraints and duties associated with the permission granted to redistribute data.

The invention may include a specially programmed computer system comprising one or more computer processors, interactive interfaces, electronic storage devices, and networks. The computer implemented system, method and medium described herein provide unique advantages to entities, organizations, market data consumers and other users. An embodiment of the present invention is directed to providing a streamlined and simplified data rights capture tool that effectively and accurately ascertains the meaning of complex and specialized agreements. The innovative system and method seek to reduce hidden legal and other risks of non-compliance with data licensing contracts or agreements by ensuring that rights are purchased in an accurate, efficient and comprehensive manner in accordance with business objectives.

These and other advantages will be described more fully in the following detailed description.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIG. 1 is an exemplary flow diagram, according to an embodiment of the present invention.

FIG. 2 is an exemplary system diagram, according to an embodiment of the present invention.

FIG. 3 is an exemplary user interface, according to an embodiment of the present invention.

FIG. 4 is an exemplary user interface, according to an embodiment of the present invention.

FIG. 5 is an exemplary user interface, according to an embodiment of the present invention.

FIG. 6 is an exemplary user interface, according to an embodiment of the present invention.

FIG. 7 is an exemplary user interface, according to an embodiment of the present invention.

FIG. 8 is an exemplary hierarchy of contracts, according to an embodiment of the present invention.

FIG. 9 is an exemplary user interface, according to an embodiment of the present invention.

FIG. 10 is an exemplary user interface, according to an embodiment of the present invention.

FIG. 11 is an exemplary illustration of usage rights models components, according to an embodiment of the present invention.

FIG. 12 is an exemplary user interface, according to an embodiment of the present invention.

FIG. 13 is an exemplary workflow illustrating single to multi-contract summary, according to an embodiment of the present invention.

FIG. 14 is an exemplary workflow illustrating single to multi-contract usage rights, according to an embodiment of the present invention.

FIG. 15 is an exemplary workflow illustrating single to multi-contract usage rights, according to an embodiment of the present invention.

### DETAILED DESCRIPTION OF THE PREFERRED EMBODIMENT(S)

The following description is intended to convey an understanding of the present invention by providing specific embodiments and details. It is understood, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending upon specific design and other needs.

An embodiment of the present invention is directed to a complex data rights tool that captures the meaning of agreements in an accurate and efficient manner. Market data agreements are generally specialized and unique in nature, where meanings of terms will change from agreement to agreement. Moreover, an entity, such as a financial institution, will regularly engage in hundreds, if not thousands and thousands of market data agreements. An embodiment of the present invention recognizes that simply applying natural language processor will not adequately capture such complex data rights.

The complex data rights tool of an embodiment of the present invention enables users to (1) select usage rights, (2) define the asset (e.g., dataset) and (3) define the scope of use for the defined dataset. In addition, this process (or variation thereof) may be repeated multiple times for the same contract.

With an embodiment of the present invention, complex data rights may be captured by a series of screens, panels, windows, interfaces, etc. For example, an asset interface may enable the user to identify an asset or dataset covered by a contract. Various fields may be identified through a series of predetermined options. This may be available through various interfaces and options, such as drop down windows or other variations. Where appropriate, text input may be applied as well. The asset or dataset may be defined by various fields including vendor contracting with, a different vendor may deliver the data, frequency that the data is to be delivered, how the data is delivered, etc.

An embodiment of the present invention may then define the use of the data in the agreement. The scope may be restricted or confined by the use of the data. The data may be filtered to a use case to a specific criteria defined in the contract. This may include confining the use of data to a physical location, specific region, city, desk, line of business, etc. An embodiment of the present invention may use fixed or predetermined fields to maintain consistency and uniformity in data. Other restrictions may involve a specific application or even individual users or groups. For example, this may be applicable when an entity is purchasing a range of user licenses. In this example, an embodiment of the present invention may enable a user to specify a number or range of users. Accordingly, an embodiment of the present invention provides flexibility in defining the scope of where data may be used.

An embodiment of the present invention may be directed to defining usage rights. The usage rights may be based on a standard derived data package. An embodiment of the present invention may further provide flexibility to refine and/or redefine options for use in various contracts.

A summary interface that compiles a user's input into a single package or solution may be provided. There may be instances where an agreement has multiple datasets with essentially the same terms. Once a scope and terms are acceptable, the process may be replicated with various datasets. In this example, a user may refine or fine-tune a specific dataset if needed or desired. For example, a user may work on a complicated agreement with many different rights that have been defined. An embodiment of the present invention provides an interface tool that enables a user to jump back and forth through various sections of the agreement.

An embodiment of the present invention may store and manage complex rights impacted by data licenses in a graph database, for example. With the graph database, an embodiment of the present invention may link up sections of the policy in a way that represents relationship between objects. For example, a notification object, or “node”, may be related to a permission “node”, which in turn would be related to an “asset” node. This means that licensor permits licensee to use the asset, but may require them to notify the licensor of that fact. Further refinements may be made through properties of objects. This further enables users to traverse the policy more easily and determine applicability. With multiple policies managed in a graph database, an embodiment of the present invention may better identify and address holistic issues. This may involve determining whether one type of rights has been purchased for the same group more than once, which could result in unnecessary spend and wasted resources. In a scenario involving thousands of agreements, the types of rights defined in these agreements may depend on a hierarchy of different contracts and the meaning they impart. An embodiment of the present invention may traverse a wide tree of contracts to then determine whether a right was unnecessarily purchased more than once. Other issues may be resolved as well, including whether a particular user can use data in a specified manner. Accordingly, an embodiment of the present invention is directed to managing usage rights across a variety of contracts in a particular dataset.

An embodiment of the present invention may be directed to tracking rights based on various contracts, agreements and applications. The various embodiments of the present invention may be applied to rights that have been purchased or otherwise licensed. This may be further extended to physical items, equipment, etc. which may be defined by client contracts, for example.

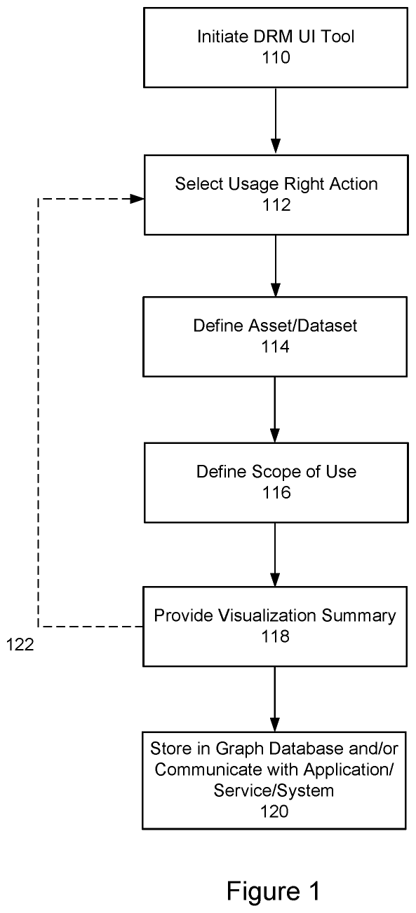

FIG. 1 is an exemplary flow diagram, according to an embodiment of the present invention. At step 110, a digital rights management tool may be initiated. At step 112, usage right actions may be identified. This may occur by enabling a user to select from a predetermined set of selections, e.g., drop down windows. At step 114, an asset or dataset may be defined. At step 116, the scope of use may be defined. At step 118, visualization of the selections may be provided for confirmation. Changes as well as updates may be implemented. At step 120, the complex data rights may be stored in a database, such as a graph database and then communicated with other applications, systems, etc. While the process of FIG. 1 illustrates certain steps performed in a particular order, it should be understood that the embodiments of the present invention may be practiced by adding one or more steps to the processes, omitting steps within the processes and/or altering the order in which one or more steps are performed. For example, step 112 may repeat after step 118, as shown by 122, as needed.

At step 110, a digital rights management (DRM) tool may be initiated. The DRM tool may be integrated with a complex digital rights management tool, application compliance portal, or a data ordering tool. The tool may be provided through a portal or other interactive interface. Other variations may be implemented.

At step 112, usage right actions may be identified. Usage rights may relate to how the data can be used. For example, usage may be represented by various categories including Derive (e.g., produce resultant data, where source data cannot be reverse-engineered), Redistribution (e.g., external distribution), Distribution (e.g., internal distribution), Store (e.g., ability to store data internally) and Sub-License (e.g., make data available to a third party). Other usage patterns may be implemented.

According to an exemplary illustration, usage right scenarios may include Derived Data—Standard; Index Creation, Non-Display-Trading and DDLA (Derived Data Licensing Agreement).

Derived Data may include criteria for deriving from raw data. Data in this category cannot be reverse engineered back to raw or original dataset. In addition, Derived Data is not used as a substitute and further does not track the raw data. For example, Derived Data—Standard may apply to the ability to create Derived Data. With Derived Data—Standard, there may be criteria for deriving raw data. This may include: the derived data cannot be reverse engineered back to raw/original dataset; it is not used as a substitute; does not track the raw data; redistribute derived data; create an index or financial product (is either silent or allowed). Other restrictions may apply. This may not apply if the contract does not allow creation indices or financial products.

Index creation may include a specific license for index creation, either “derived data” or “non-display.” Index creation may include an ability to create an index or financial instrument. It cannot be reversed engineered back to raw or original data. It is not a substitute or does not track an existing product. Other restrictions may apply.

Non-Display-Trading may include specific license for use of data in applications where the raw data is not displayed. Derived output cannot be viewed by users. The data may be used for algorithm or automated trading. Data format description may be required. This may include: derived output cannot be viewed by users; used for algorithm/automated trading; data format description if required; ability to create indices. Other restrictions may apply.

DDLA may represent where an additional derived data license agreement is required to cover. Specific use cases may be defined. This may include bespoke or exclusive datasets. In addition, multiple websites or public portals may be involved. This may also involve reduced restrictions on format and other conditions.

Redistribution—Custom may include “standard” settings plus defined wider scope in contract. This may include: quantity; a defined distribution frequency; ability to send to more clients or prospective clients or third parties; different or extractable formats; include in client presentations.

Distribution—Standard may involve data that may be sent externally. This may be based on certain criteria including, for example, small amount in graph, PDF or other format; sent ad hoc or one-off basis; in ordinary course of business; to one other user; not enough to substitute client buy data, etc.

Other usage right models may include Redistribution—Standard; Sub-License Standard and Storage—Standard.

Redistribution—Standard may refer to a fixed or small amount of data that is deemed okay to be sent externally. This may be based on certain criteria including, for example, small amount in graph, PDF or other format; sent ad hoc or one-off basis; in support of a discussion or trade; to a client; not enough to substitute client buy data; not going to a vendor or third party, etc.

Sub-License Standard may refer to an ability to use a third party. Raw data may be derived based on certain conditions, such as the data cannot be reverse engineered back to raw or original dataset; it is not used as a substitute; does not track the raw data; covers new original works, etc. Derived data is not an index or financial instrument.

Storage—Standard may refer to an ability to store data internally. Data may be deemed okay to be stored internally based on certain criteria, including small amount in graph, PDF or other format; sent ad hock or one-off basis; in support of a discussion or trade; to a client; not enough to be a substitute and not going to a vendor or third party.

At step 114, an asset or dataset may be defined. An embodiment of the present invention is directed to defining assets. Asset or dataset may be defined by specifying various data fields including Carrier Vendor, Data Frequency, Platform, Contract Vendor and Data Category. Other information may include service description and service name.

At step 116, the scope of use may be defined. This may involve identifying any restrictions to the scope of use for the defined dataset. Scope may be defined by Physical, Logical, LOB/Entity, Application/Other and Individual Users. Physical may apply where the scope of the contract is restricted to a physical location (e.g., global, regional, city, office, etc.) or other geographic boundary. Logical may apply where the scope of the contract is restricted to a logical constraint (e.g., buy-side, sell-side, custody, enterprise, etc.). LOB/Entity may apply where the scope of the contract is to a specific business or other area (e.g., LOB, desk, individual, desktop, etc.). Application/Other may apply where the scope of contract is restricted not by location, entity or LOB but by platform, application or website. Individual users may apply where the scope of contract is restricted by specific users, group or type of users. For example, this may include individual licensed user, specified number of authorized users, specified range of users, unlimited users within defined scope. Some conditions may include no consultants or contractors permitted, no sharing of logins and no simultaneous logins. Other restrictions and/or conditions may apply.

At step 118, visualization of the selections may be provided for confirmation. For example, an embodiment of the present invention may provide a summary interface of the user's selection. This summary interface enables the user to jump back and forth between various sections for additional edits and updates. A user could also be allowed to edit a specific section, copy a part of entire rights definition to a new section, delete rules or sections, etc. Optionally, this visualization may also be called on-demand via a feature of the interface, similar to how a shopping cart view may be implemented on an e-commerce platform. Other methods or capabilities may apply.

At step 120, the complex data rights may be stored in a database, such as a SQL or a graph database and then communicated with other applications, systems, etc. For example, an embodiment of the present invention may communicate with or be integrated with other applications, systems and services that are internal and/or external. Such systems may include a digital rights visualizer, market data analytics tool, Digital Rights Management policy store, rights ordering workflow, etc.

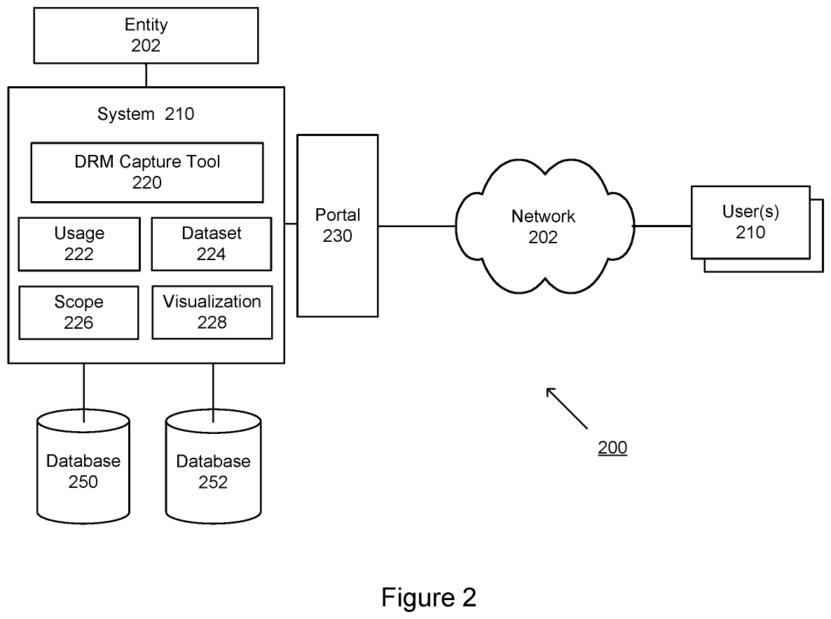

FIG. 2 is an exemplary system diagram, according to an embodiment of the present invention. FIG. 2 may include System 210, DRM Capture Tool 220 and Interactive Portal 230. System 210 may manage and analyze market data contract terms. DRM Capture Tool 220 may be integrated with various applications, services, platforms and/or systems. For example, DRM Capture Tool 220 may communicate and/or integrate with systems, such as an Open Digital Rights Language (ODRL) Visualizer and Market Data Contract Analytics Tool. An embodiment of the present invention may be integrated with an ODRL visualizer that automatically translates digital agreements from machine readable language into human readable language. The ODRL Visualizer is described in co-pending and commonly assigned patent application titled “System and Method for Implementing an Open Digital Rights Language Visualizer,” U.S. Ser. No. 62/957,443, filed Jan. 6, 2020 (Attorney Docket Number: 72167.001810), the contents of which are incorporated by reference herein in their entirety. A Market Data Contract Analytics Tool enables users to visualize usage rights. This may include visualizing rights an entity has licensed from various providers or sources. Other features may include search capabilities, visualization of agreements the entity has signed or entered into, and analytics on various aspects of the agreements including associated text and metadata. The Market Data Contract Analytics Tool is described in co-pending and commonly assigned patent application entitled “System and Method for Implementing a Market Data Contract Analytics Tool,” U.S. patent application Ser. No. 16/904,156, filed Jun. 17, 2020 (Attorney Docket Number: 72167.001874), the contents of which are incorporated by reference herein in their entirety. For example, with this integration, a user may search for a particular keyword as applied to a line of business (LOB) or a specific desk. An embodiment of the present invention may store data relating to digital agreements in a graph database where a user may then select relevant factors and collapse results for specifically what the user is looking for.

An embodiment of the present invention may be tied to an entitlement system. The entitlement system may access an output of a system integrated with ODRL enhancement. Additional details are provided in co-pending and commonly assigned patent application entitled “System and Method for Implementing an Open Policy Agent Bridge,” U.S. patent application Ser. No. 17/018,134, filed Sep. 11, 2020 (Attorney Docket Number: 72167.001883) the contents of which are incorporated by reference herein in their entirety.

DRM Capture Tool 220 may include functions and features including Usage 222, Dataset 224, Scope 226 and Visualization 228.

Usage 222 may define usage rights for the dataset. Usage rights be based on criteria for deriving raw data, specific licenses for index creation, specific licenses for use of data in applications, redistribution settings and distribution settings.

Dataset 224 may define the assets and specific datasets. This may involve identifying data fields from a predetermined set of options.

Scope 226 may define the scope of use for the identified assets and/or datasets. This may involve identifying restrictions, including physical, logical and line of business or entity. Other restrictions and/or conditions may be identified.

Visualization 228 may generate interactive and dynamic visualizations of the captured data rights. Various formats and interfaces may be applied. For example, Visualization 228 may provide a summary of Data Usage, Application request details and Scope(s). In this example, Data Usage may indicate DDLA, Non-Display-Trading and Index Creation. Application details may specify Website/webApp; Source name, Delayed and Indices. Scope(s) may indicate Physical, Logical, LOB/Entity and Application/Other. Visualization 228 may enable a user to then apply the same (or similar) rights to multiple other datasets and thereby replicate the data capture process. In addition, a user may refine and/or update the selections.

Portal 230 may represent an interactive user interface or an application compliance portal that allows users, such as application owners, to capture and analyze complex data rights in a simplified and streamlined manner.

Entity 202, such as a financial institution, may host System 210. Users may interact with Portal 230 via Network 202. Portal 230 may provide an interactive user interface that receives user's inputs and requests. Users may be represented by 210. User 210 may communicate with Portal 230 via Network 202 to access System 210 and DRM Capture Tool 220. DRM Capture Tool 220 may send and/or receive data from various sources, including Databases 250, 252. Databases 250, 252 may store data relating to agreements, contracts, terms, analytics, visualizations, digital and other rights, etc. Databases 250, 252 may represent a graph database and/or other analytics system.

The system 200 of FIG. 2 may be implemented in a variety of ways. Architecture within system 200 may be implemented as hardware components (e.g., module) within one or more network elements. It should also be appreciated that architecture within system 200 may be implemented in computer executable software (e.g., on a tangible, non-transitory computer-readable medium) located within one or more network elements. Module functionality of architecture within system 200 may be located on a single device or distributed across a plurality of devices including one or more centralized servers and one or more mobile units or end user devices. The architecture depicted in system 200 is meant to be exemplary and non-limiting. For example, while connections and relationships between the elements of system 200 are depicted, it should be appreciated that other connections and relationships are possible. The system 200 described below may be used to implement the various methods herein, by way of example. Various elements of the system 200 may be referenced in explaining the exemplary methods described herein.

Network 202 may be a wireless network, a wired network or any combination of wireless network and wired network. For example, Network 202 may include one or more of an Internet network, a satellite network, a wide area network (“WAN”), a local area network (“LAN”), an ad hoc network, a Global System for Mobile Communication (“GSM”), a Personal Communication Service (“PCS”), a Personal Area Network (“PAN”), D-AMPS, Wi-Fi, Fixed Wireless Data, IEEE 802.11a, 802.11b, 802.15.1, 802.11g, 802.11n, 802.11ac, or any other wired or wireless network for transmitting or receiving a data signal. Also, Network 202 may support an Internet network, a wireless communication network, a cellular network, Bluetooth, or the like, or any combination thereof. Network 202 may further include one, or any number of the exemplary types of networks mentioned above operating as a stand-alone network or in cooperation with each other. Network 202 may utilize one or more protocols of one or more network elements to which it is communicatively coupled. Network 202 may translate to or from other protocols to one or more protocols of network devices. Although Network 202 is depicted as one network for simplicity, it should be appreciated that according to one or more embodiments, Network 202 may comprise a plurality of interconnected networks, such as, for example, a service provider network, the Internet, a cellular network, corporate networks, or even home networks, or any of the types of networks mentioned above.

Data may be transmitted and received via Network 202 utilizing a standard networking protocol or a standard telecommunications protocol. For example, data may be transmitted using Session Initiation Protocol (“SIP”), Wireless Application Protocol (“WAP”), Multimedia Messaging Service (“MMS”), Enhanced Messaging Service (“EMS”), Short Message Service (“SMS”), Global System for Mobile Communications (“GSM”) based systems, Code Division Multiple Access (“CDMA”) based systems, Transmission Control Protocol/Internet Protocols (“TCP/IP”), hypertext transfer protocol (“HTTP”), hypertext transfer protocol secure (“HTTPS”), real time streaming protocol (“RTSP”), or other protocols and systems suitable for transmitting and receiving data. Data may be transmitted and received wirelessly or in some cases may utilize cabled network or telecom connections such as an Ethernet RJ45/Category 5 Ethernet connection, a fiber connection, a cable connection or other wired network connection.

While FIG. 2 illustrates individual devices or components, it should be appreciated that there may be several of such devices to carry out the various exemplary embodiments. Users may communicate with various entities using any mobile or computing device, such as a laptop computer, a personal digital assistant, a smartphone, a smartwatch, smart glasses, other wearables or other computing devices capable of sending or receiving network signals. Portal 230 may represent a user interface and/or other interactive communication portal.

System 210 may be communicatively coupled to Databases 250, 252. Databases 250, 252 may include any suitable data structure to maintain the information and allow access and retrieval of the information. For example, Databases 250, 252 may keep the data in an organized fashion and may be an Oracle database, a Microsoft SQL Server database, a DB2 database, a MySQL database, a Sybase database, an object oriented database, a hierarchical database, a flat database, and/or another type of database as may be known in the art to store and organize data as described herein.

Databases 250, 252 may be any suitable storage device or devices. The storage may be local, remote, or a combination thereof with respect to Databases 250, 252. Databases 250, 252 may utilize a redundant array of disks (RAID), striped disks, hot spare disks, tape, disk, or other computer accessible storage. In one or more embodiments, the storage may be a storage area network (SAN), an internet small computer systems interface (iSCSI) SAN, a Fiber Channel SAN, a common Internet File System (CIFS), network attached storage (NAS), or a network file system (NFS). Databases 250, 252 may have back-up capability built-in. Communications with Databases 250, 252 may be over a network, or communications may involve a direct connection between Databases 250, 252 and Entity 202, as depicted in FIG. 2. Databases 250, 252 may also represent cloud or other network based storage.

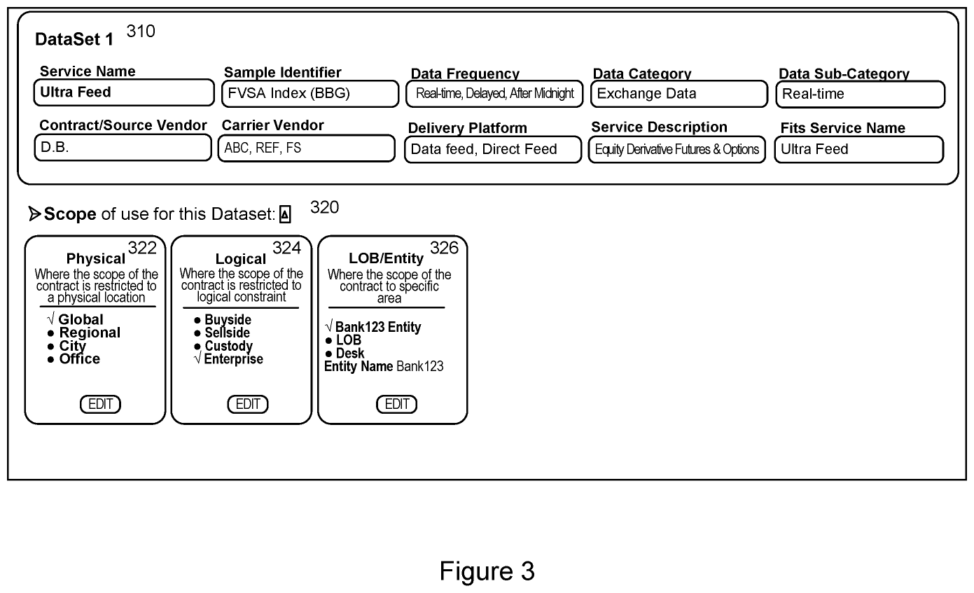

FIG. 3 is an exemplary interface illustrating usage rights, according to an embodiment of the present invention. An exemplary interface may include DataSet, Scope and Usage Rights. FIG. 3 may illustrate an interface with an example where the criteria required to identify the dataset is defined together with scope of use and usage rights permitted.

Under Dataset 310 may represent data fields. Data fields may change or vary based on applications, use cases, scenarios and other factors. The data fields illustrated in FIGS. 3-12 are merely illustrative and do not limit the scope of the various embodiments of the present invention in any manner. Exemplary data fields may include Service Name, Sample Identifier, Data Frequency, Data Category, Data Sub-Category, Contract/Source Vendor, Carrier Vendor, Delivery Platform, Service Description and Service Name. Multiple assets may be identified and added.

Scope 320 may define scope of use for the defined Dataset. Scope may be defined by Physical 322, Logical 324, LOB/Entity 326, etc. Physical 322 may be applied where the scope of the contract is restricted to a physical location, such as global, regional, city, office, etc. Logical 324 may be applied where the scope of the contract is restricted to a logical constraint, e.g., buy side, sell side, custody, enterprise, etc. LOB/Entity 326 may be applied where the scope of the contract is to a specific area, e.g., Bank Entity, LOB (line of business), desk entity name, etc.

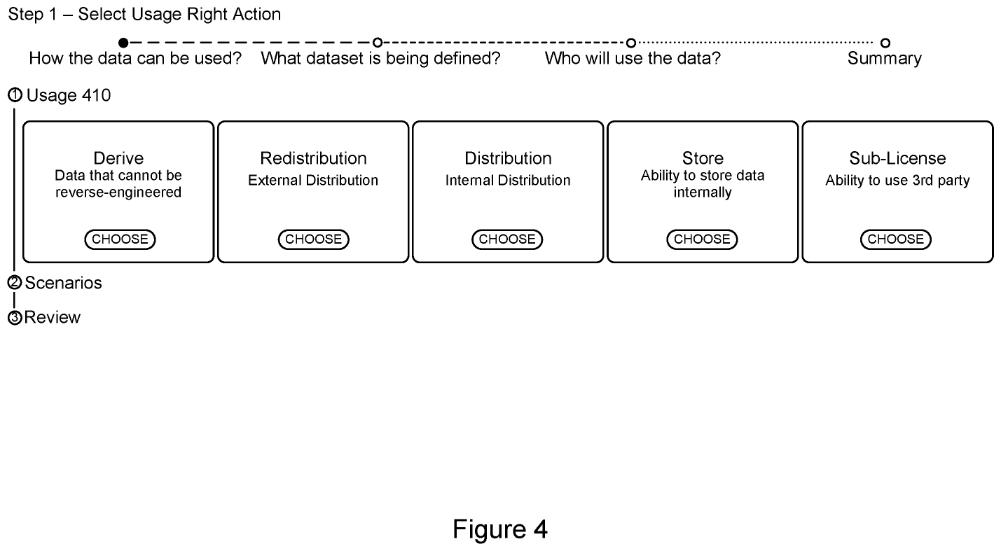

FIG. 4 is an exemplary user interface, according to an embodiment of the present invention. An embodiment of the present invention may walk a user through a sequence of steps. In this example, step 1 is directed to selecting a usage right action at 410. This generally refers to how data can be used. As shown in FIG. 4, a user may choose Derive (e.g., produce resultant data, where source data cannot be reverse-engineered), Redistribution (e.g., external distribution), Distribution (e.g., internal distribution), Store (e.g., ability to store data internally) and Sub-License (e.g., make data available to a third party). Other usage patterns may be implemented. In addition, other categories may be added or names changes as technology continues to evolve.

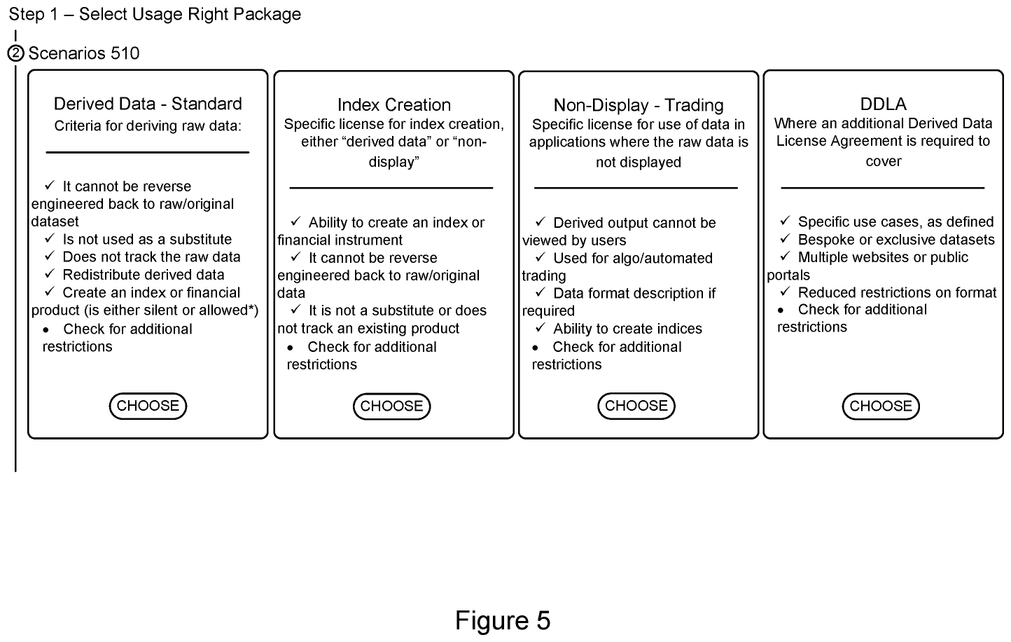

FIG. 5 is an exemplary user interface, according to an embodiment of the present invention. FIG. 5 illustrates an exemplary set of scenarios that a user may select from at 510. Additional details for each of the scenario, or new scenarios, may be provided. In this example, a user may select a scenario from Derived Data—Standard, Index Creation, Non-Display—Trading and DDLA.

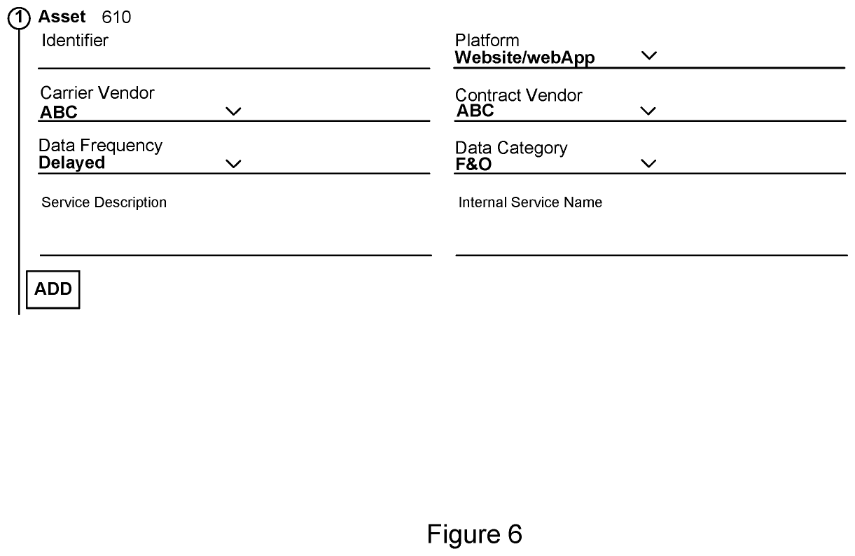

FIG. 6 is an exemplary interface, according to an embodiment of the present invention. An embodiment of the present invention is directed to defining assets. This may involve defining a dataset. As shown in FIG. 6, data fields may be identified including Carrier Vendor, Data Frequency, Platform, Contract Vendor and Data Category. Other information may include service description and internal service name. After selections are made, an embodiment of the present invention may provide a review of the Asset with the previously identified Data Usage.

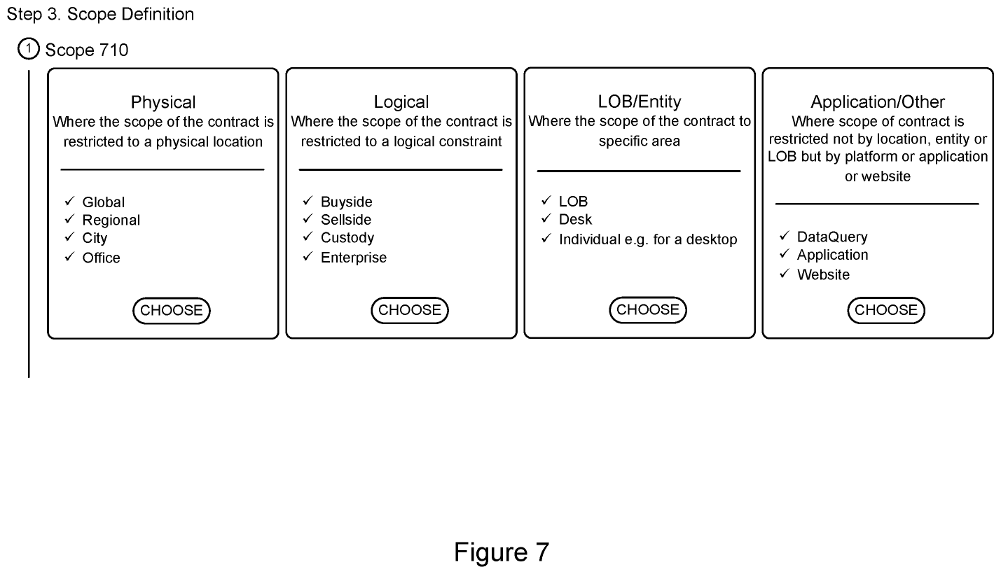

FIG. 7 is an exemplary user interface, according to an embodiment of the present invention. As shown in FIG. 7, a user may define scope of use for the identified asset at 710. The user may restrict scope by selecting from a set of scope definitions, including Physical, Logical, LOB/Entity and Application/Other.

An embodiment of the present invention is directed to capturing key usage rights and relevant constraints in an interactive interface. This facilitates creating a digitized version of the rights into ODRL and further provides tools to search across multiple contracts, vendors and/or datasets.

An embodiment of the present invention may first define a contract hierarchy and create a consolidated version of the terms. This may be realized as a single view. An embodiment of the present invention may model each new document onto previous terms, thereby creating a final version that accumulates the terms across the agreements. For example, an embodiment of the present invention may combine a master distribution agreement (MDA), order schedule to the MDA and amendment to the order schedule. The latest version of terms in a hierarchy may represent a consolidation of the MDA with any schedules or successive amendments, as it generally states that this document takes precedence in any conflicts but not always.

An embodiment of the present invention is directed to logically merging digital versions of contracts within a hierarchy (e.g., master services agreement, addendum, schedule, exhibit, etc.) and providing a consolidated view that combines all the rights, while providing an indication of which term came from what document. The indication may also provide how the term is used in context. For this feature, an embodiment of the present invention may overlay ODRL of one agreement over the previous one, substituting and/or replacing details of terms. This may be repeated or iterated multiple times as needed to match a specific scope being assessed. This feature allows users, such as lawyers and data analysts, to answer specific business questions about various digital rights that apply to them vis-à-vis a specific data set. This feature realizes significant efficiencies over the current process of locating and extracting contracts from various systems of record, reading and analyzing all relevant agreements. A resultant summary may then be presented in a table or color-coded format to indicate which document a specific right or obligation came from and whether further legal or other analysis is needed. Other interfaces and graphics may be implemented.

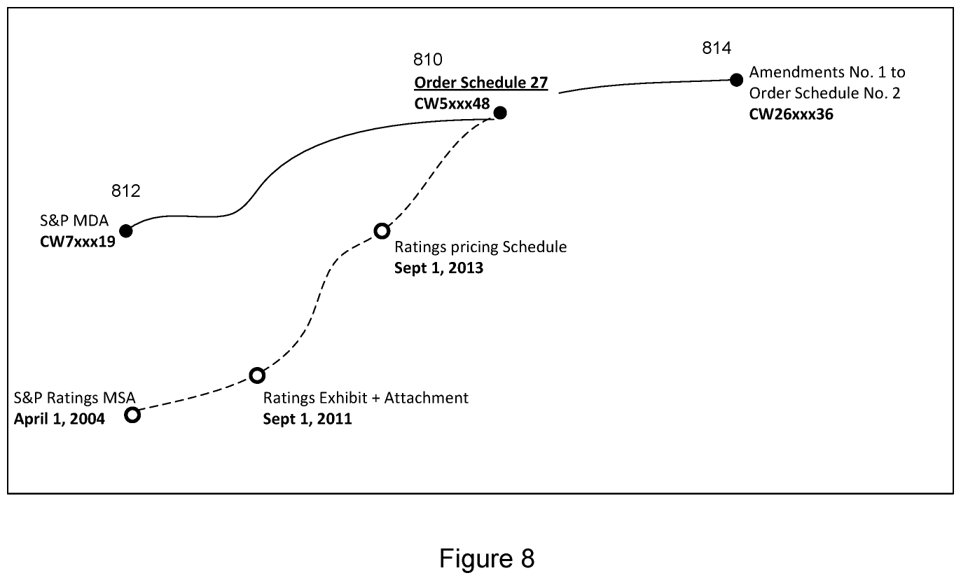

FIG. 8 is an exemplary hierarchy of contracts, according to an embodiment of the present invention. As shown in FIG. 8, an embodiment of the present invention connects a hierarchy of contracts at the outset to retrieve prevailing terms and associated inter-dependencies within other documents. The dashed lines indicate that if a ratings subscription is terminated, Schedule 2 will also be automatically terminated. Contract 810 represents an Order Schedule, which has an associated MDA at 812 and an amendment at 814.

Contracts may be stored with their underlying contract data to support vendor parent alignment. For example, contracts may be stored and managed by an embodiment of the present invention. Each contract may be identified by an identifier (CW number), contract name (A&B Financial Services Master Agreement), document type (Master Agreement), effective date, parent name (A&B Global Inc.), supplier name (A&B Financial Services LLC), etc.

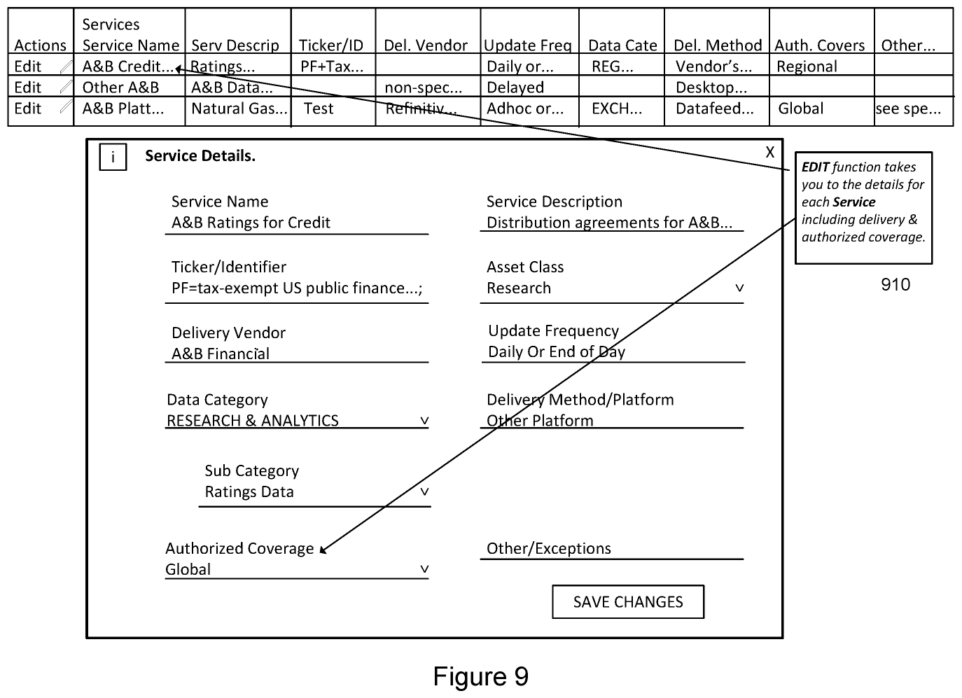

FIG. 9 is an exemplary user interface, according to an embodiment of the present invention. With FIG. 9, a user may edit existing services. As shown in FIG. 9, multiple services may be added to each contract, which describe the datasets covered and contain the same or variable usage rights. In this example at 910, the Edit Function may take the user to the details for each service including delivery and authorized coverage.

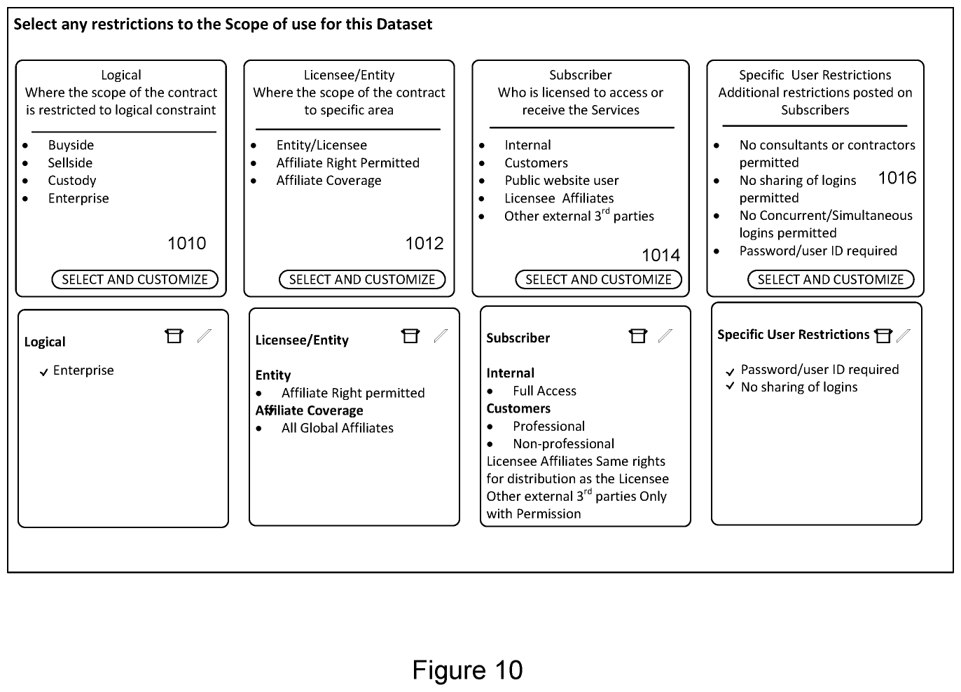

FIG. 10 is an exemplary user interface, according to an embodiment of the present invention. With FIG. 10, a user may add rights management. As shown in FIG. 10, the scope of the services may be selected in an intuitive process which leads the user through each requirement and then summarizes coverage. Services may be defined along with who will use the data. Restrictions may be selected to the scope of use for the dataset. This may include Logical 1010, Licensee 1012, Subscriber 1014 and Specific User Restrictions 1016. Logical 1010 may represent where the scope of the contract is restricted to logical constraints. Licensee 1012 may represent where the scope of the contract is to a specific area. Subscriber 1014 may represent who is licensed to access or receive the services. Specific User Restrictions 1016 may represent additional restrictions posed on subscribers. Other conditions may be identified and applied.

An embodiment of the present invention is directed to usage right models. First, a user may select one or more conditions that apply. This may involve customizing the rights to specify how the defined services can be used (e.g., subject to conditions) and how to distribute the defined services (e.g., subject to conditions). For example, services may be distributed externally or shared with third parties subject to conditions. A user may select one or more conditions. Conditions may include: For authorized subscribers only; As described in each order form; Format requires prior approval by vendor; In limited amounts; On an adhoc or one-off basis; in PDF or non-extractable format; in a non-manipulable, view only format; via emails, via SFTP, etc.

Next, a user may select the duties that apply to the permission. This may define how the defined services may be used and what conditions may apply. Duties may include: Requires a legally binding Customer Agreement; Requires a legally binding Customer Agreement signed with specified provisions included; Requires T&Cs (terms and conditions) displayed clearly on website; Requires T&Cs displayed clearly on website with specified provisions included; Additional agreement required for other uses; If other data received beyond the stated, will require additional license to use or distribute; Attribution required; End User Agreement required; Only with approval and separate license; Adding after-acquired affiliates requires approval, etc.

Next, a set of constraints and duties associated with permissions being granted to redistribute the data may be provided. This may include details concerning: the services that can be distributed externally; subscriber details; duties to be distributed in a format approved by vendor; duties to be distributed externally, duties for distribution in a manipulable format, duties to be distributed via SFTP; duties for distribution via emails; and duties for distribution in conjunction with primary business functions, etc.

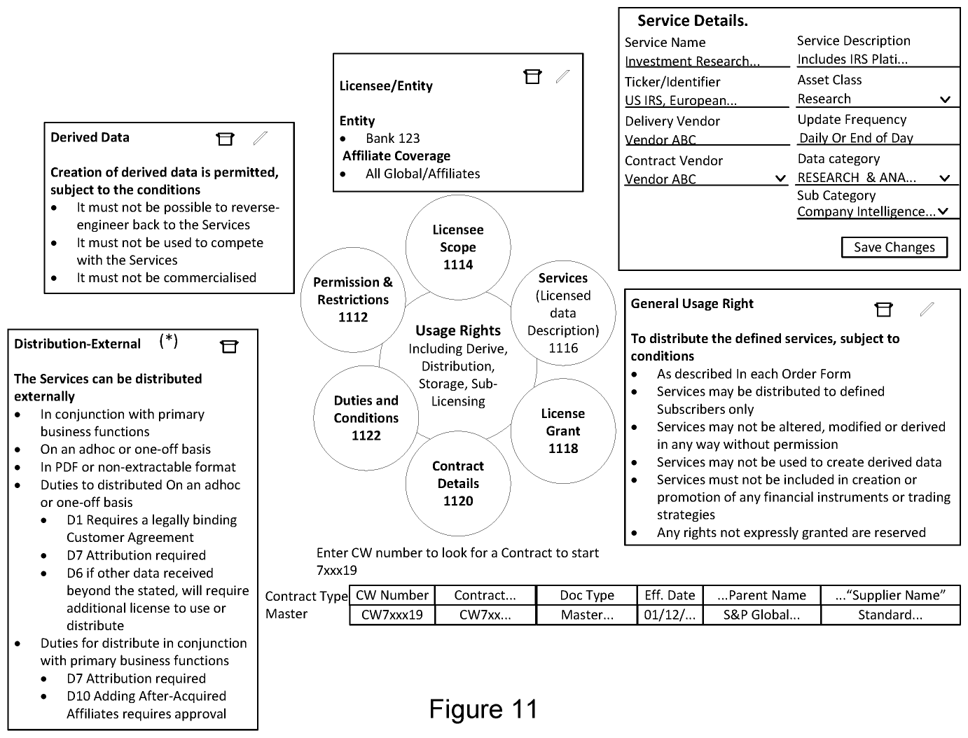

FIG. 11 is an exemplary illustration of usage rights models components, according to an embodiment of the present invention. Usage Rights 1110 may relate to deriving data, distributing data, storing data, sub-licensing data and/or other actions. Usage Rights 1110 may be defined by Permissions and Restrictions 1112, Licensee Scope 1114, Services 1116, License Grant 1118, Contract Details 1120 and Duties and Constraints 1122. Permissions and Restrictions 1112 may relate to permitting creation of derived data, subject to conditions. Licensee Scope 1114 may identify entities, affiliate coverage, etc. Services 1116 may include licensed data description including service name, ticker/identifier, delivery vendor, contract vendor, service description, asset class, update frequency, data category, sub category, etc. License Grant 1118 may include general usage rights. This may relate to using the defined services subject to conditions and distributing the defined services subject to conditions. Contract Details 1120 may be provided including number, contract identifier, document type, effective date, parent name, supplier name, etc. Duties and Conditions 1122 may include services that can be distributed externally.

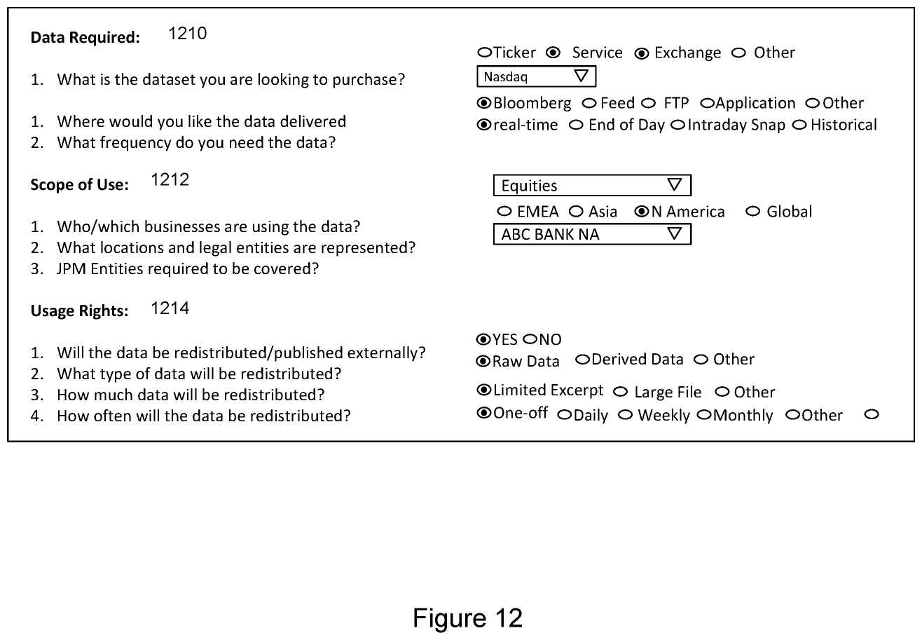

FIG. 12 is an exemplary user interface, according to an embodiment of the present invention. FIG. 12 may include a Data Required section 1210, Scope of Use section 1212 and Usage Rights section 1214. Data Required section 1210 may identify the dataset, where the data is to be delivered and frequency of data delivery. Scope of Use section 1212 may include who or which businesses are using the data, locations and legal entities and entities to be covered. Usage Rights section 1214 may include whether the data will be redistributed or published externally, the type of data to be redistributed, how much data will be distributed and how often the data will be distributed. FIG. 12 is exemplary only and other information may be obtained and applied.

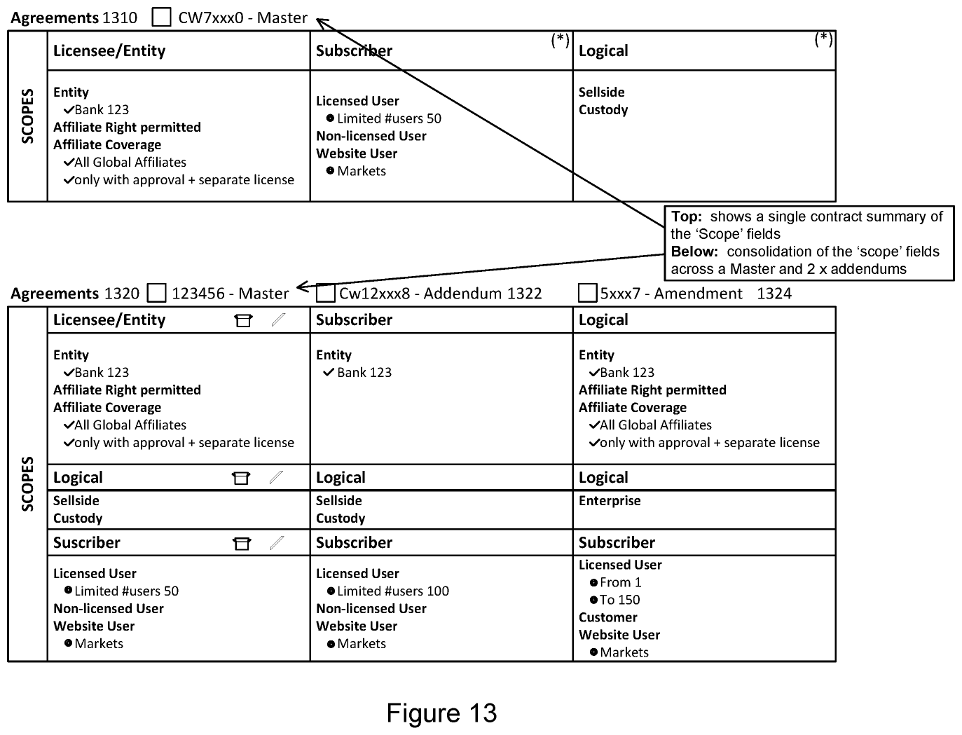

FIG. 13 is an exemplary workflow illustrating single to multi-contract summary, according to an embodiment of the present invention. At 1310, a single contract summary of the “Scope” fields is shown. 1310 represents an agreement involving Licensee Entity, Subscriber and Logical details. At 1320, a consolidation of the “Scope” fields across a Master and two Addendums is illustrated. As shown here, Master Agreement 1320 is shown with Addendum 1322 and Amendment 1324, with corresponding details concerning Licensee Entity, Logical details and Sub scriber data.

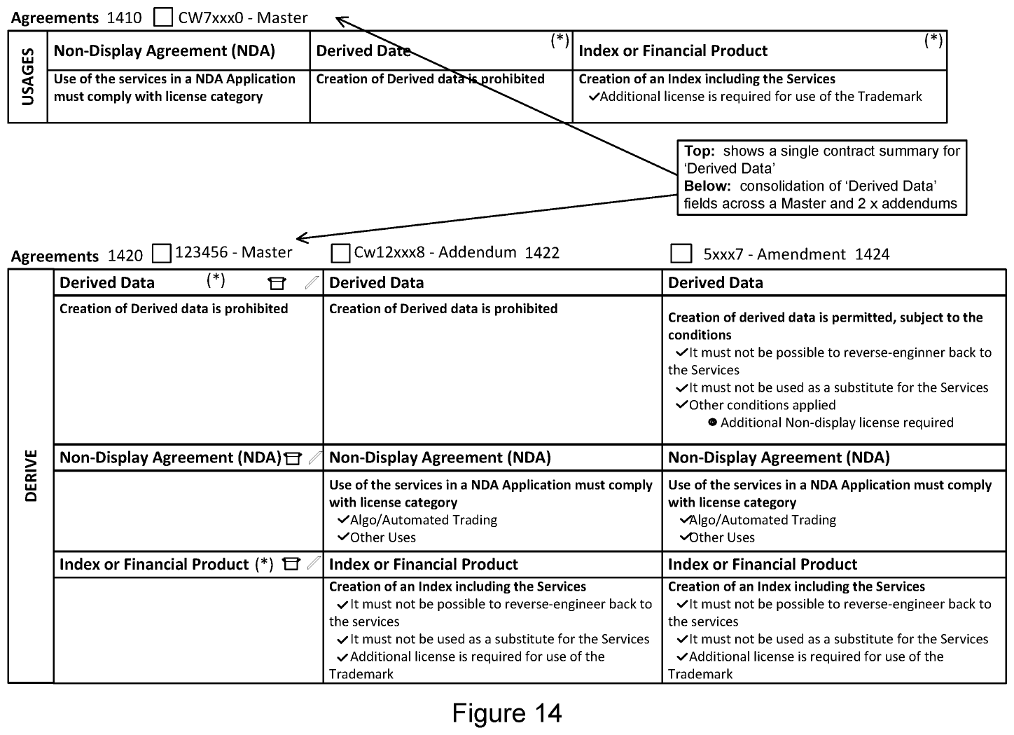

FIG. 14 is an exemplary workflow illustrating single to multi-contract usage rights, according to an embodiment of the present invention. FIG. 14 illustrates details concerning Terms and Conditions. At 1410, a single contract summary for “Derived Data” is shown. 1410 represents an agreement with Non-Display Agreement (NDA), Derived Data and Index or Financial Product. At 1420, a consolidation of “Derived Data” fields across a Master and two Addendums is illustrated. As shown here, Master Agreement 1420 is shown with Addendum 1422 and Amendment 1424, with corresponding details concerning Derived Data, Non-Display Agreement and Index or Financial Product details.

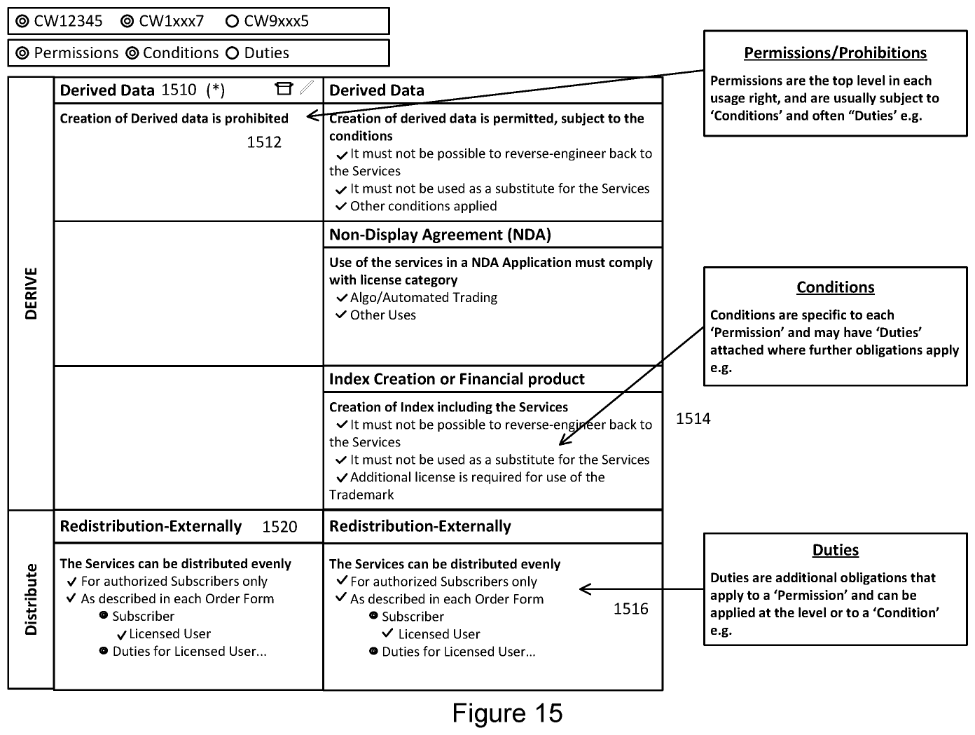

FIG. 15 is an exemplary workflow illustrating single to multi-contract usage rights, according to an embodiment of the present invention. FIG. 15 illustrates usage rights relating to Derived Data 1510 and Distribution/Redistribution 1520. As shown by 1512, creation of derived data is prohibited. In this example, Permissions represent the top level in each usage right and may be usually subject to “conditions” and often “duties.” This may include: creation of derived data is permitted, subject to permissions; creation of derived data is prohibited; use of services in an NDA is permitted; use of services in an NDA is prohibited; use of services to create an index is permitted, subject to conditions, etc. Other permissions, prohibitions may be defined and applied.

As shown by 1514, conditions may be specific to each “permission” and may have “duties” attached where further obligations may apply. For example, conditions may include: it must not be possible to reverse-engineer back to the services; it must not be used as a substitute for the services; for Algo/Automated Trading only; other uses, as defined; limited extracts; adhoc or non-systematic, etc. Other conditions may be defined and applied.

As shown by 1516, duties may represent additional obligations that apply to a “permission” and can be applied at that level or to a “condition.” This may include: requires a legally binding customer agreement; attribution required (if redistributing data); requires prior approval and additional license; if other data received beyond the stated, will require additional license; etc. Other duties may be defined and applied.

The foregoing examples show the various embodiments of the invention in one physical configuration; however, it is to be appreciated that the various components may be located at distant portions of a distributed network, such as a local area network, a wide area network, a telecommunications network, an intranet and/or the Internet. Thus, it should be appreciated that the components of the various embodiments may be combined into one or more devices, collocated on a particular node of a distributed network, or distributed at various locations in a network, for example. As will be appreciated by those skilled in the art, the components of the various embodiments may be arranged at any location or locations within a distributed network without affecting the operation of the respective system.

As described above, the various embodiments of the present invention support a number of communication devices and components, each of which may include at least one programmed processor and at least one memory or storage device. The memory may store a set of instructions. The instructions may be either permanently or temporarily stored in the memory or memories of the processor. The set of instructions may include various instructions that perform a particular task or tasks, such as those tasks described above. Such a set of instructions for performing a particular task may be characterized as a program, software program, software application, app, or software.

It is appreciated that in order to practice the methods of the embodiments as described above, it is not necessary that the processors and/or the memories be physically located in the same geographical place. That is, each of the processors and the memories used in exemplary embodiments of the invention may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two or more pieces of equipment in two or more different physical locations. The two distinct pieces of equipment may be connected in any suitable manner. Additionally, the memory may include two or more portions of memory in two or more physical locations.

As described above, a set of instructions is used in the processing of various embodiments of the invention. The servers may include software or computer programs stored in the memory (e.g., non-transitory computer readable medium containing program code instructions executed by the processor) for executing the methods described herein. The set of instructions may be in the form of a program or software or app. The software may be in the form of system software or application software, for example. The software might also be in the form of a collection of separate programs, a program module within a larger program, or a portion of a program module, for example. The software used might also include modular programming in the form of object oriented programming. The software tells the processor what to do with the data being processed.

Further, it is appreciated that the instructions or set of instructions used in the implementation and operation of the invention may be in a suitable form such that the processor may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processor, i.e., to a particular type of computer, for example. Any suitable programming language may be used in accordance with the various embodiments of the invention. For example, the programming language used may include assembly language, Ada, APL, Basic, C, C++, COBOL, dBase, Forth, Fortran, Java, Modula-2, Pascal, Prolog, REXX, Visual Basic, JavaScript and/or Python. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of various embodiments of the invention may utilize any compression or encryption technique or algorithm, as may be desired. An encryption module might be used to encrypt data. Further, files or other data may be decrypted using a suitable decryption module, for example.

In the system and method of exemplary embodiments of the invention, a variety of “user interfaces” may be utilized to allow a user to interface with the mobile devices or other personal computing device. As used herein, a user interface may include any hardware, software, or combination of hardware and software used by the processor that allows a user to interact with the processor of the communication device. A user interface may be in the form of a dialogue screen provided by an app, for example. A user interface may also include any of touch screen, keyboard, voice reader, voice recognizer, dialogue screen, menu box, list, checkbox, toggle switch, a pushbutton, a virtual environment (e.g., Virtual Machine (VM)/cloud), or any other device that allows a user to receive information regarding the operation of the processor as it processes a set of instructions and/or provide the processor with information. Accordingly, the user interface may be any system that provides communication between a user and a processor. The information provided by the user to the processor through the user interface may be in the form of a command, a selection of data, or some other input, for example.

The software, hardware and services described herein may be provided utilizing one or more cloud service models, such as Software-as-a-Service (SaaS), Platform-as-a-Service (PaaS), and Infrastructure-as-a-Service (IaaS), and/or using one or more deployment models such as public cloud, private cloud, hybrid cloud, and/or community cloud models.

Although the embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes.

What is claimed is:

1. A system that implements a data rights capture tool, the system comprising:
a portal that interfaces with user within a line of business via a network communication;
a memory component that stores data relating to a plurality of contracts associated with the line of business; and
an analytics engine that comprises a computer processor and is coupled to the memory component and the portal; the computer processor is further configured to perform the steps of:
initiating, via the portal, the data rights capture tool;
providing, via the portal, a set of data fields associated with an asset, the set of data fields comprising: service name, data frequency, source vendor data and carrier vendor data;
receiving, via the portal, one or more data inputs associated with the set of data fields;
providing, via the portal, a scope of use for the asset, wherein the scope of use relates to one or more of: physical restriction, logical restriction and line of business restriction;
receiving, via the portal, one or more data inputs associated with the scope of use for the asset;
providing, via the portal, one or more usage rights for the asset; and
providing, via the portal, a visualization of the asset, the scope of use for the asset and the one or more usage rights for the asset.

2. The system of claim 1, wherein the set of data fields further comprises: data category, data sub-category, delivery platform and service description.

3. The system of claim 1, wherein the physical restriction comprises a physical location comprising global, regional, city and office.

4. The system of claim 1, wherein the logical restriction comprises a constraint relating to one or more of: buy-side, sell-side, custody and enterprise.

5. The system of claim 1, wherein the line of business restriction restricts the scope to a specific area comprising entity, line of business and desk.

6. The system of claim 1, wherein the one or more usage rights comprise one or more of: derived data which includes criteria for deriving raw data and index creation.

7. The system of claim 1, wherein the one or more usage rights comprise one or more of: use of data in applications where the raw data is not displayed, rights relating to redistribution and rights relating to distribution of data.

8. A system that implements a data rights capture tool, the system comprising:
a portal that interfaces with user within a line of business via a network communication;
a memory component that stores data relating to a plurality of contracts associated with the line of business; and
an analytics engine that comprises a computer processor and is coupled to the memory component and the portal; the computer processor is further configured to perform the steps of:
initiating, via the portal, the data rights capture tool;
defining a contract hierarchy and creating a consolidated version of one or more terms associated with the contract hierarchy;
identifying a service and a dataset covered by the contract hierarchy and defined by the one or more terms;
identifying, via the portal, a scope of use for the service, wherein the scope of use relates to what one or more services are being defined and who will use an associated dataset;
receiving, via the portal, one or more conditions relating to distribution of the service;
receiving, via the portal, one or more duties that apply to one or more permissions relating to distribution of the service; and
generating, via the portal, a visualization of a set of constraints and duties associated with the permission granted to redistribute data.

9. The system of claim 8, wherein the contract hierarchy comprise a master service agreement and one or more of: addendum, schedule and exhibit.

10. The system of claim 8, wherein the one or more conditions comprise: one or more recipients and a distribution format.

11. The system of claim 8, wherein the one or more duties comprise: inclusion of legal documents or related documents.

12. The system of claim 8, wherein the visualization further comprises an indication of a term and which document the term came from.

13. The system of claim 12, wherein the indication further provides context on how the term is used in the document.

14. The system of claim 12, wherein the indication further specifies where a specific right or obligation is found in which document.

15. A method that implements a data rights capture tool, the method comprising the steps of:
initiating, via a portal, the data rights capture tool, wherein the portal interfaces with a user within a line of business via a network communication;
defining, via an analytics engine comprising a computer processor, a contract hierarchy and creating a consolidated version of one or more terms associated with the contract hierarchy;
identifying, via the analytics engine, a service and a dataset covered by the contract hierarchy and defined by the one or more terms;
identifying, via the portal, a scope of use for the service, wherein the scope of use relates to what one or more services are being defined and who will use an associated dataset;
receiving, via the portal, one or more conditions relating to distribution of the service;
receiving, via the portal, one or more duties that apply to one or more permissions relating to distribution of the service; and
generating, via the portal, a visualization of a set of constraints and duties associated with the permission granted to redistribute data.

16. The method of claim 15, wherein the contract hierarchy comprise a master service agreement and one or more of: addendum, schedule and exhibit.

17. The method of claim 15, wherein the one or more conditions comprise: one or more recipients and a distribution format.

18. The method of claim 15, wherein the one or more duties comprise: inclusion of legal documents or related documents.

19. The method of claim 15, wherein the visualization further comprises an indication of a term and which document the term came from.

20. The method of claim 19, wherein the indication further provides context on how the term is used in the document and specifies where a specific right or obligation is found in which document.
